(19) United States
(12) Patent Application Publication
(10) Pub. No.: US 2025/0362998 A1
(43) Pub. Date: Nov. 27, 2025

(54) PROVIDING WEB PAGES WITH GENERATED CONTENT IN RESPONSE TO UNIFORM RESOURCE LOCATOR BASED PENETRATION ATTACKS

(71) Applicants: Peng YAO, Fort Lauderdale, FL (US); Lei ZHOU, Fort Lauderdale, FL (US); Tianyu XIAO, Fort Lauderdale, FL (US); Citrix Systems, Inc., Fort Lauderdale, FL (US)

(72) Inventors: Peng Yao, Nanjing (CN); Lei Zhou, Nanjing (CN); Tianyu Xiao, Nanjing (CN)

(21) Appl. No.: 18/873,383

(22) PCT Filed: Sep. 30, 2022
(86) PCT No.: PCT/CN2022/120388

§ 371 Date: Dec. 10, 2024

(51) Int. Cl. G06F 11/07; G06F 16/955

(52) U.S. Cl. CPC G06F 11/0793; G06F 16/9566

(57) ABSTRACT

The present solution provides systems and methods for generating and serving web pages to a client in response to invalid URL requests The present solution can include an echo server that receives, from a web server, an indication of an incorrect request from a client device being received by web server The echo server can establishing a second web page based at least on a web page selected from the web server The echo server can provide content of the second web page based at least on one or more parameters of the uniform resource location (URL) of the incorrect request The echo server can provide the second web page to the web server to cause the web server to provide the second web page in response to the incorrect request to the client device instead of an error code

### RELATED APPLICATIONS

This application claims the benefit of and is a National Stage filing under 35 U.S. §371 of International Patent Cooperation Treaty (PCT) Application No. PCT/CN2022/120388 (filed Sep. 30, 2022), which is incorporated here by reference in its entirety.

### FIELD OF THE DISCLOSURE

The present application generally relates to computing systems and environments, including but not limited to systems and methods for responding to network penetration attacks.

### BACKGROUND

Network traffic can vary widely based on the nature of devices, systems, and user actions. While providing online content to different users, web servers can face different network security threats. Some threats can include penetration attacks by malicious users. In order to provide a safe network environment, network security measures may be utilized.

### SUMMARY

This summary is provided to introduce a selection of concepts in a simplified form that are further described below in the Detailed Description. This Summary is not intended to identify key features or essential features, nor is it intended to limit the scope of the claims included herewith.

When attempting to gain illegal access to a server providing web pages, malicious users can use a set of parameters based on existing uniform resource locator (URL) paths of publically available web pages. Using these set of parameters, the malicious users can attempt to identify URLs of hidden web pages of the server. Once identified, the hidden pages can be used to mount subsequent attacks and potentially compromise the server. In addition, while attempting to identify the hidden web pages using URL-based parameters, malicious users can filter invalid web responses from the server using automated filtering tools that can identify common features of the standard responses that servers issue to different invalid URL requests. Using these automated filtering tools, malicious users can mount continuous and more efficient attempts to uncover hidden URL paths without having to manually analyze server responses. The present solution precludes the usage of such automated tools by the malicious users by providing, in response to invalid URL requests, automatically generated web pages whose content matches the keywords and style of the real public web pages previously provided the users. In doing so, the present solution makes the server responses to the malicious URL requests difficult to filter via automated tools.

In some aspects, the present solution can relate to a method. The method can include a server receiving from a web server an indication of an incorrect request from a client device being received by web server. The server can establish a second web page based at least on a web page selected from the web server. The server can provide content of the second web page based at least on one or more parameters of the uniform resource location (URL) of the incorrect request. The server can provide the second web page to the web server to cause the web server to provide the second web page in response to the incorrect request to the client device instead of an error code.

The method can include the server receiving the incorrect request redirected to the server by the web server. The server can receive the incorrect request responsive to the web server determining the URL of the incorrect request identifies an unfound web page. The server can select the web page of a plurality of web pages of the web server that was previously provided to the client device.

The method can include generating text for the content of the second page based at least on one or more parameters of the incorrect request. The method can include generating text comprising a number of words within a threshold of the web page selected from the web server. The server can generate the second web page based at least on a style of the web page selected from the server. The server can cause the web server to reply to the incorrect request with a response comprising a success status with the second web page.

In some aspects the present disclosure relates to a system. The system can include one or more processors coupled to memory. The one or more processors can be configured to receive, from a web server, an indication of an incorrect request from a client device being received by web server. The one or more processors can be configured to establish a second web page based at least on a web page selected from the web server. The one or more processors can provide content of the second web page based at least on one or more parameters of the uniform resource location (URL) of the incorrect request. The one or more processors can provide the second web page to the web server to cause the web server to provide the second web page in response to the incorrect request to the client device instead of an error code.

The one or more one or more processors can receive the incorrect request redirected to the server by the web server. The incorrect request can be received responsive to the web server determining the URL of the incorrect request identifies an unfound web page. The one or more processors can select the web page of a plurality of web pages of the web server that was previously provided to the client device. The one or more processors can generate text for the content of the second page based at least on one or more parameters of the incorrect request.

The one or more processors can generate text comprising a number of words within a threshold of the web page selected from the web server. The one or more processors can generate the second web page based at least on a style of the web page selected from the server. The one or more processors can cause the web server to reply to the incorrect request with a response comprising a success status with the second web page.

In some aspects, the present solution relates to a non-transitory computer readable medium storing program instructions. The instructions can cause at least one processor of a server to receive, from a web server, an indication of an incorrect request from a client device being received by web server. The instructions can cause at least one processor of a server to establish a second web page based at least on a web page selected from the web server. The instructions can cause at least one processor of a server to provide content of the second web page based at least on one or more parameters of the uniform resource location (URL) of the incorrect request. The instructions can cause at least one processor of a server to provide the second web page to the web server to cause the web server to provide the second web page in response to the incorrect request to the client device instead of an error code.

The instructions can cause at least one processor of a server to receive the incorrect request redirected to the server by the web server. The incorrect request can be redirected responsive to the web server determining the URL of the incorrect request identifies an unfound web page. The instructions can cause at least one processor of a server to select the web page of a plurality of web pages of the web server that was previously provided to the client device. The instructions can cause at least one processor of a server to generate text for the content of the second page based at least on one or more parameters of the incorrect request. The can include a number of words within a threshold of the web page selected from the web server. The instructions can cause at least one processor of a server to generate the second web page based at least on a style of the web page selected from the server. The instructions can cause at least one processor of a server to cause the web server to reply to the incorrect request with a response comprising a success status with the second web page.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 1D is a block diagram depicting a computing environment comprising client device in communication with cloud service providers, in accordance with an illustrative embodiment;

FIG. 2 is a block diagram of an appliance or a server for processing communications between a client and a server, in accordance with an illustrative embodiment;

FIG. 3 includes a block diagram of an example system for providing webpages with automatically generated content in response to the URL-based penetration attacks, in accordance with an illustrative embodiment;

FIG. 4 includes an example communication process between the components of the system of the present solution, in accordance with an illustrative embodiment;

FIG. 5 includes an example web page provided to a client in response to a client request, in accordance with an embodiment of the present solution;

FIG. 6 includes an example web page provided to a client in response to a client request when an generated web page is not provided to the client, in accordance with an illustrated embodiment;

FIG. 7 includes an example web page provided to a client in response to a client request includes a generated web page created in accordance with an embodiment of the present solution;

FIG. 8 includes a flow diagram of an example method of providing webpages with automatically generated content in response to the URL-based penetration attacks, in accordance with an illustrative embodiment;

### DETAILED DESCRIPTION

When attempting to gain illegal access to a server, malicious users can mount penetration attacks against the server by using published web pages provided by the server to identify hidden pages that can be exploited to access the server. Particularly, a malicious user can design a set of parameters based on a uniform resource locator (URL) of a public web page provided by the server to form new URLs with which it can attempt to identify potential hidden pages. While attempting to identify a hidden page using different URL based parameters, the malicious user can filter out and exclude server responses indicative of invalid web page requests. Invalid web page responses can often be identified based on their common features, such as, for example, an http 401 or 404 error status, an unusual response length (e.g., a very short response), or certain web page keywords (e.g., “Page Not Found”). Based on these common features, malicious users can use automated tools to efficiently filter out the unsuccessful attempts, which allows malicious users to implement automated and continuous URL-based parameter attempts at the server in order to more quickly locate the hidden URL paths.

The present disclosure provides a solution that, in response to a request for a web page not found based on a received client request, automatically generates a new web page whose content is similar to that of the web page already served to the user from the same server. In doing so, the present solution provides a response to an invalid web page request of the malicious user matches the look the look and content of the real web page from the server making them difficult to filter out from as common invalid web page responses by the malicious user scripts for the automated penetration. In doing so the present solution prevents the malicious users from being able to use automated filters and tools to gain illegal access to the web servers, improving the security of the servers providing web content.

For purposes of reading the description of the various embodiments below, the following descriptions of the sections of the specification and their respective contents may be helpful:

Section A describes a network environment and computing environment which may be useful for practicing embodiments described herein;

Section B describes embodiments of systems and methods for delivering a computing environment to a remote user;

Section C describes embodiments of systems and methods for providing web pages with generated content in response to penetration attacks

### A. Network and Computing Environment

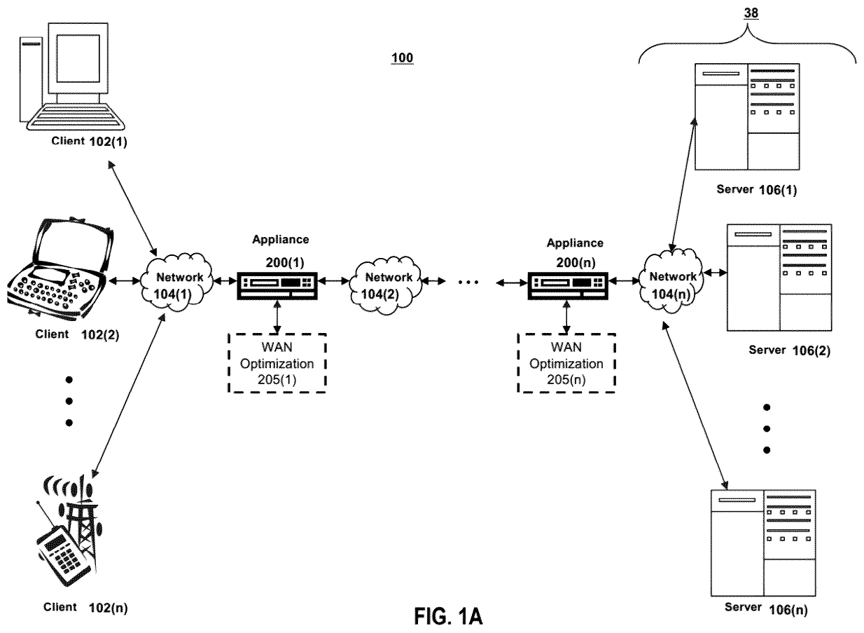

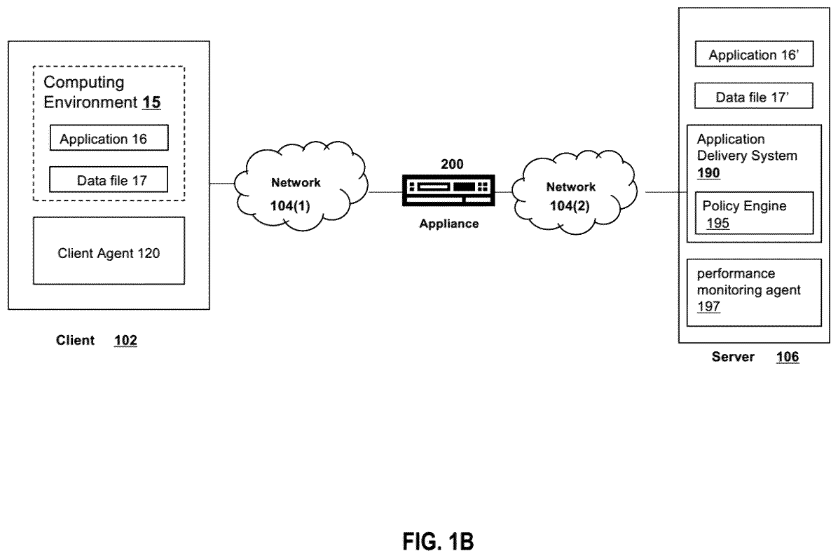

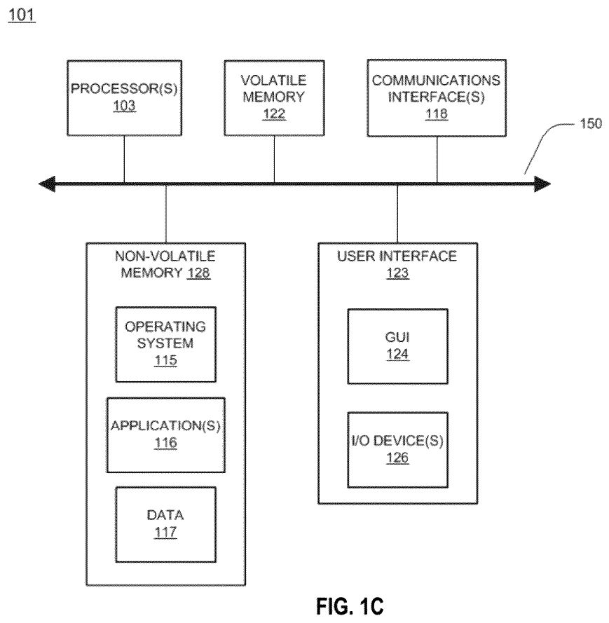

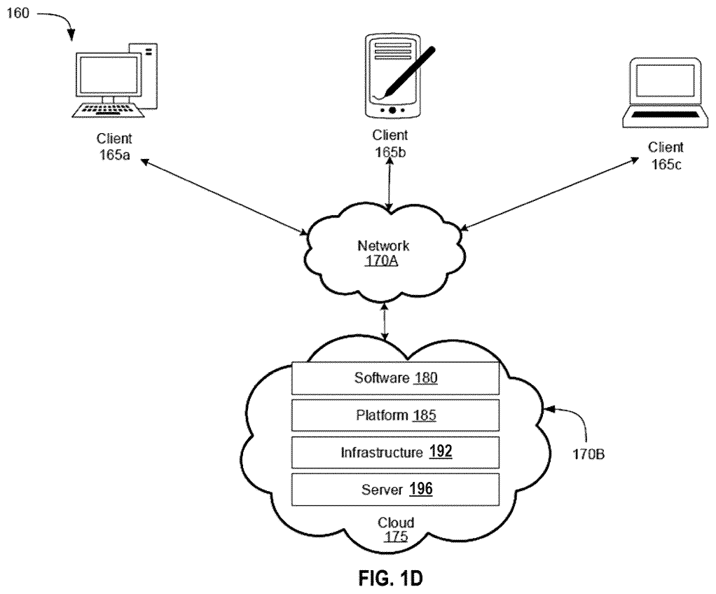

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, FL.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, FL.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix DaaS™ (formerly Citrix Virtual Apps and Desktops, XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, FL. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, FL.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

Additional details of the implementation and operation of network environment 100, clients 102, servers 106, and appliances 200 and 205 may be as described in U.S. Pat. No. 9,538,345, issued Jan. 3, 2017 to Citrix Systems, Inc. of Fort Lauderdale, FL, the teachings of which are hereby incorporated herein by reference.

Referring to FIG. 1D, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers 196, processing, memory, storage, applications, virtual machines, databases, software, hardware, analytics, and intelligence.

In embodiments, the computing environment 160 may provide client 165 with one or more resources provided by a network environment. The computing environment 165 may include one or more clients 165a-165n, in communication with a cloud 175 over one or more networks 170A, 170B. Clients 165 can include any functionality or features of clients 102 and vice versa. Clients 165 may include, e.g., thick clients, thin clients, and zero clients. The cloud 175 may include back end platforms, e.g., servers 196, storage, and server farms or data centers. Clients 165 can be the same as or substantially similar to computer 100 of FIG. 1C.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers 196 that are maintained by third parties to clients 165 or the owners of the clients 165. The servers 196 may be located off-site in remote geographical locations as disclosed above or otherwise. Public clouds 175 may be connected to the servers 196 over a public network 170. Private clouds 175 may include private servers 196 that are physically maintained by clients 165 or owners of clients 165. Private clouds 175 may be connected to the servers 196 over a private network 170. Hybrid clouds 175 may include both the private and public networks 170A, 170B and servers 196.

The cloud 175 may include back end platforms, e.g., servers 196, storage, server farms or data centers. For example, the cloud 175 can include or correspond to a server 196 or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 192. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Appliance Architecture

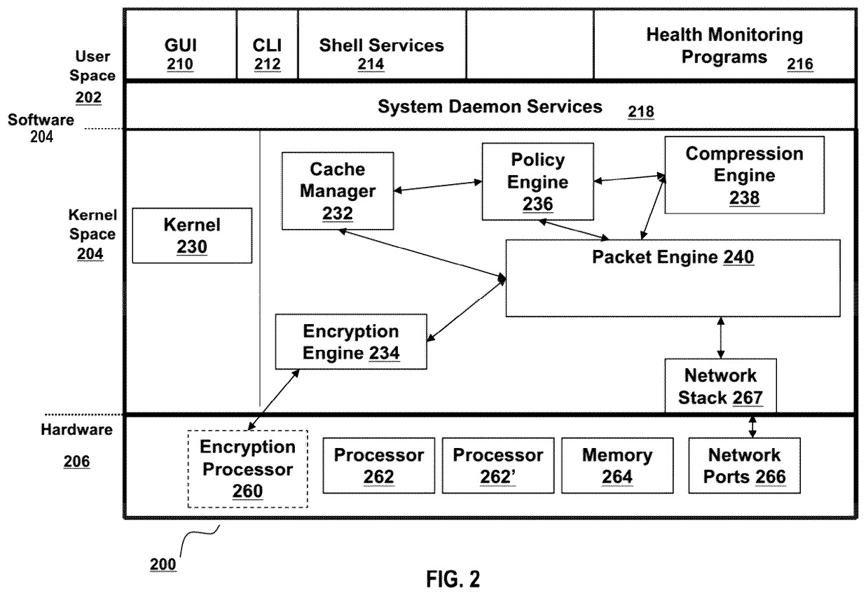

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 204 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application 104. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, FL. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

Additional details of the implementation and operation of appliance 200 may be as described in U.S. Pat. No. 9,538,345, issued Jan. 3, 2017 to Citrix Systems, Inc. of Fort Lauderdale, FL, the teachings of which are hereby incorporated herein by reference.

C. Providing Web Pages with Generated Content in Response to Penetration Attacks

The present solution can include systems and methods that can provide web pages with content generated based on previously served public web pages, in response to potential URL-based penetration attacks. As web page requests with incorrect URLs can be indicative of an ongoing URL-based penetration attack, upon receiving an incorrect URL request from a client, the present solution can generate and serve to the client a web page with a particular generated content. The generated content can be based on a web page that was previously served to the same client. The content can match the style, length and key words of the content of the previously served public web page, thereby making it difficult to automatically filter the served web page, provided in response to the incorrect URL request, in the event that the incorrect URL request is a part of an ongoing malicious URL-based penetration attack by the client.

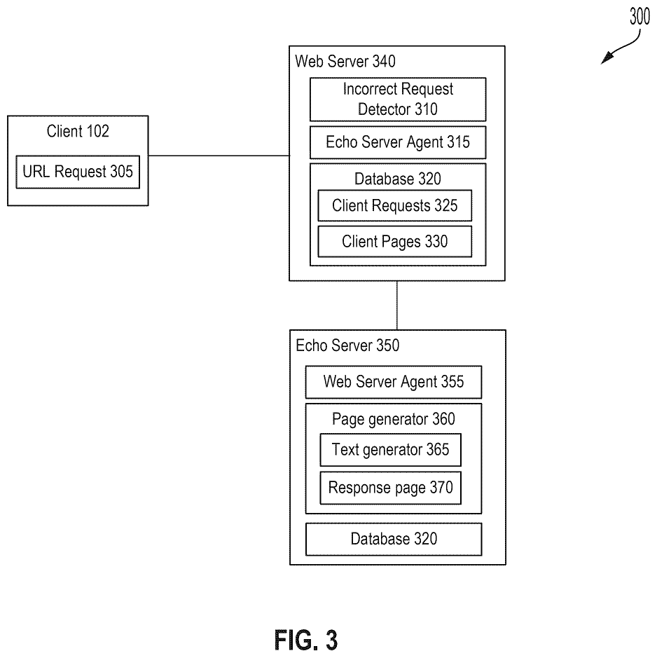

Referring now to FIG. 3, a system 300 for automatically generating and serving web pages to a client in response to invalid URL requests, is illustrated. System 300 can include a client 102 generating a URL request 305 and in communication with a web server 340 that is also in communication with echo server 350. Web server 340 can include an incorrect request detector 310, an echo server agent 315 and a database 320 storing the prior client requests 325 and prior served client pages 330. Echo server 350 can include a web server agent 355 for communicating with the web server 340, a database 320 and a page generator 360 having a text generator 365 for generating a response page 370 for the client 102 in response to the client's URL request 305.

As the client 102 device can be operated by a potentially malicious user generating a URL request 305 that includes an incorrect URL generated as a part of an ongoing URL-based penetration attack on the web server 340, the incorrect request detector 310 of the web server 340 can identify the URL request 305 as an incorrect request and send it to the echo server 350. The web server 320 can also send to the echo server 350 information about the prior client request 325 and previously served client pages 330. Using the previously served client pages 330, the page generator 360 can utilize text generator 365 to generate a response page 370 to be sent back to the web server 340, which can then forward the response to the client 102, responsive to the URL request 305.

URL request 305 can include any request by a client to access a web page on a server, such as a server 106, web server 340 or echo server 350. URL request 305 can include any network request involving a uniform resource locator (URL). A URL request 305 can include a hypertext transfer protocol (HTTP) request, a hypertext transfer protocol secure (HTTPS), a remote procedure calls (RPCs) request, a message queueing (AMQP) request, a domain name system (DNS) request or any other type and form of request that can be used to gain access to a web page on a server. URL request 305 can be a request to access a web page in response to a click on a link or a hyperlink on a web page. URL request 305 can include or correspond to a uniform resource identifier (URI). URL request 305 can include any type and form of characters for identifying a web page on a server, such as a server 106, web server 340 or echo server 350. URL request 305 can include a host and a path for identifying a particular web page. URL request 305 can include any combination of one or more of a protocol indicator, a subdomain, a domain name, a root domain, a top level domain, a slug, a directory or a path, an article permalink and an anchor. URL request 305 can include a query string, a query string separator, a fragment and a name of the web page. URL request 305 can include combination of features or components to correctly identify a web page on web server 340.

URL request 305 can include a portion of a URL that is incorrect or identifying a non-existing web page. For example, URL request 305 can include a correct domain name, a correct top level domain and a correct geographical domain, but an incorrect directory or a file path. URL request 305 can include the direction or a file path that is edited, modified or generated based on one or more file paths of one or more other existing web pages. The domain name of the URL request 305 can be based on a domain name of the website, while having a file path which the website does not provide, does not advertise or does not make available to the general public. For example, URL request 305 can include a file path to a hidden web page that is not made available to the general public. For example, URL request 305 can include a file path that is randomly generated or generated by an algorithm for guessing or identifying the most likely file paths of hidden web pages on web servers 330. URL request 305 can include a file path that is selected by a malicious user during the attempt to guess, uncover or identify a hidden web page on the web server 305. The hidden web page can be any web page that can be accessed using the correct URL, but whose URL is not published, not made available to the general public or not made available to the client 102.

Web server 340 be can any server providing web content. Web server 340 can include any network device providing web pages, web sites or web services to the clients 102. Web server 340 can include any functionality of a server 106, server 196, cloud platform 185, or cloud infrastructure 192. Web server 340 can include the functionality to receive from clients 102 various URL requests 305 requests to access web pages identified by the URLs. Web server 340 can include the functionality to respond to the requests from the clients 102 by providing the pages identified by the URLs in the URL requests 305. Web server 340 can provide to the client 102 an error code, such as a 401 or 404 error code, or a web page stating “Page Not Found.”

Incorrect request detector (IRD) 310 can include any combination of hardware and software for detecting incorrect URL requests 305. Incorrect request detector 310 can include any scripts, computer code, functions or instructions stored in memory (e.g., 264) and executed on processors (e.g., 260, 262) to detect URL requests 305 that are incorrect, invalid or otherwise not directed to an existing web page or a web page that can be served to the client 102. Incorrect request detector 310 can include the functionality to check whether the URL corresponds to an existing web page or a web page that can be served to client 102. Incorrect request detector 310 can include the functionality to check the file path of the URL against file paths of the existing web pages or web pages that are available to the client 102. Incorrect request detector 310 can determine that the URL request 305 is incorrect, invalid or suspicious based on identifying that the URL in the URL request 305 does not correspond to a web page that exists or a web page that can be served or provided to the client 102.

Echo server agent 315 can include any agent on a web server 340 for facilitating communication with the echo server 350, or for providing communication between the web server 340 and the echo server 350. Echo server agent 315 can include scripts, functions, computer code or instructions that are executed on processors (e.g., 260, 262) to facilitate communication or exchange of data, URL requests 305 and contents of the database 320 between the web server 340 and the echo server 350. Echo server agent 315 can establish and maintain communication, sessions or connections with the echo server 350. Echo server agent 315 can provide the echo server 350 with URL requests 305 identified as incorrect, invalid or suspicious, along with the client requests 325 and client pages 330 corresponding to the same client 102 that has issued the URL request 305.

Database 320 can include any organized collection of structured information or data stored in memory, such as memory 128 or 264. Database 320 can include a file system and/or tables of information for storing data. Database 320 can store any information or metadata on connections between clients 102, web server 340 and echo servers 350. Database 320 can store any information, including data, prior request from clients (e.g., client requests 325) and web pages previously served to the clients (e.g., client pages 330). Database 340 can store or share a copy of any information involving a client 102 in or from a cache of a web server 340 or echo server 350. Database 320 can include any information stored so as to be accessible for processing by any of the features of the server web server 340 or echo server 350.

Client request 325 can include any prior requests from client 102 that are stored in a database 320. Client request 325 can include copies of prior URL requests 305. Client requests 320 can include requests from each individual client 102, identified for that client 102. Client requests 320 can include URLs of the prior client URL requests 305. Client requests 320 can include information on the client 102 that sent the request. Client request 320 can include any metadata, such as a timestamp or any other metadata correlating, corresponding to or identifying a client page 330 provided in response to the client request 325.

Client page 330 can be any web page previously served to a client 102. Client page 330 can include a copy, such as a cached copy, of a web page served to the client 102. Client page 330 can include a web page sent in response to a URL request 305. Database 320 can include any number of client pages 330 corresponding to a client 102. Client pages 330 can include timestamps and any other metadata correlating, corresponding to or identifying the client request 325 corresponding to the client page 330. Client page 330 can include a web page made from any code, such as HTML, CSS, Java, JavaScript, Python, SQL, PHP or any other type of code used to make websites or web pages. Client page 330 can include logos, icons, links, hyperlinks, menu features and other features customized for a particular company, enterprise or a service.

Echo server 350 can be any server that replicates the requests sent by client 102. Echo server 350 can include an application, a function or a feature operating on a web server 330 and/or comprised by the web server 330. Echo server 350 can include any functionality of a web server 340. Echo server 350 can receive client requests, such as URL request 305 from web server 340. Echo server 350 can respond to the client 102 requests and can send the responses back to the web server 340. Echo server 350 can include an application that can be used to test if the connection between the client 102 and web server 340 is successful. Echo server 350 can receive URL requests 305 from the web server 340. Echo server 350 can respond to the URL requests 305 by generating a response page 370 using prior stored one or more client pages 330. Echo server 350 can send the response, with the response page 370, back to the web server 340.

Web server agent 355 can include any agent on an echo server 350 for facilitating communication with the web server 340, or for providing communication between the web server 340 and the echo server 350. Web server agent 355 can include scripts, functions, computer code or instructions that are executed on processors (e.g., 260, 262) to facilitate communication or exchange of data, URL requests 305 and contents of the database 320 between the web server 340 and the echo server 350. Web server agent 355 can establish and maintain communication, sessions or connections with the web server 340. Web server agent 355 can receive from the web server 340 URL requests 305 identified as incorrect, invalid or suspicious, along with the client requests 325 and client pages 330 corresponding to the same client 102 that has issued the URL request 305.

Page generator 360 can include any combination of hardware and software for generating web pages, such as response pages 370. Page generator 360 can include any scripts, computer code, functions or instructions stored in memory (e.g., 264) and executed on processors (e.g., 260, 262) to generate web pages, such as response pages 370 using client pages 330 and URL requests 305. Page generator 360 can include the functionality to generate static or dynamic web pages. Page generator 360 can generate web pages utilizing same types of code, scripts, computer programs or styles as those used to create client pages 330. For example, page generator 360 can generate a response page 370 using any one or more of HTML, CSS, Java, JavaScript, Python, SQL, PHP or any other code used for making any client pages 330. Page generator 360 can include the functionality to generate text, graphics, icons and logos for the response page 370. Page generator 360 can generate any content for the response page 370 including any icons, logos and graphics, functions, menu functionalities, user interface functionalities or any features particular to, corresponding to or shared with the website of a particular company, enterprise or otherwise website identified by a portion of the URL request 305, such as the domain name of the URL request 305 identifying the website for which the URL requests 305 requests a particular page.

Text generator 365 can include any combination of hardware and software for generating text and content of the response page 370. Text generator 365 can include any scripts, computer code, functions or instructions stored in memory (e.g., 264) and executed on processors (e.g., 260, 262) to generate text, words, phrases or terms used or included in the response page 370. Text generator 365 can identify and utilize phrases, words, sentences, strings of characters, or otherwise any text portions of the URL request 305 to identify phrases to be included in the text of the response page 370. Text generator 365 can identify and utilize phrases, words, sentences, strings of characters, or otherwise any text portions of the client pages 330 to be included in the text of the response page 370.

Text generator 365 can identify a particular client page 330 previously served to the same client 102 that sent the URL request 305 and use any portion of text from that particular client page 330 to generate a portion of the text or content of the response page 370. Text generator 365 can determine the size or length of the text based on the client page 330 corresponding to the client 102. Text generator 365 can determine the graphical content and the arrangement of the graphical content, including icons, colors, shapes or any graphical user interface features on the response page 370, based on the graphical content of the client page 330 corresponding to the client 102.

Text generator 365 can include the functionality for determining the length of the text to be included in the response page 370. For example, text generator 365 can determine the number of characters, words or sentences to be included in the response page 370. The number of characters, words or sentences can be determined based on the client page 330 identified as the client page 330 previously served to the client 102. The number of characters, words or sentences in the response page 370 can be based on the number of characters, words or sentences in the client page 330. For example, the size of the text in the response page 370 can be within a threshold of the text size of the client page 330. The threshold can be any number of characters or words, such as 1, 5, 10, 15, 20, 30, 50 or 100 characters or words. The threshold can correspond to a percentage of the length of the client page 330 text, such as up to 5%, 10%, 15%, 20%, 25% or more than 25% of the text.

Response page 370 can include any web page generated by the page generator 360 to respond to the URL request 305. Response page 370 can include a web page generated using any one or more of HTML, CSS, Java, JavaScript, Python, SQL, PHP or any other code used for making web pages or web sites. Response page 370 can include links to other pages. Response page 370 can be based on a client page 330 and can include the style, color, arrangement, structure, form, or any other features of the client page 300. Response page 370 can be based on one or more client pages 330 that correspond to the client 102 that sent the URL request 305. Response page 370 can include the text whose length, style, phrases or terms can be based on one or more client pages 330 corresponding to the client 102. Response page 370 can include the graphical features, logos, colors or stylistic arrangement that is based on one or more client pages 330 corresponding to the client 102.

As an example, the system 300 of the present solution can relate to one or more processors (e.g., 260, 262) that can be coupled to memory (e.g., 128, 262) and configured to perform set of programmed tasks. The one or more processors (e.g., 260, 262) can be of an echo server 350. The echo server 350 (e.g., via one or more processors) can receive, from a web server 340, an indication of an incorrect URL request 305 that was received by the web server 340 from a client device 102. The echo server 350 can establish a response page 370 (e.g., a second page) based at least on a client page 330 (e.g., a web page) selected from the web server 340. The echo server 350 can utilize page generator 360 to provide content of the response page 370 based at least on one or more parameters of the uniform resource location (URL) of the incorrect URL request 305. The echo server 350 can provide the response page 370 to the web server 340 to cause the web server 340 to provide the second web page (e.g., response page 370) in response to the incorrect URL request 305 to the client device 102 instead of an error code.

The echo server 350 can receive the incorrect request redirected to the echo server 350 by the web server 340, responsive to the web server 340 determining, by the incorrect request detector 310, that the URL of the incorrect request identifies an unfound web page. The echo server 350 can select the client page 330 of a plurality of client pages 330 of the web server 340 that was previously provided to the client device 102. The echo server 350 can utilize the text generator 365 to generate text for the content of the response page 370 based at least on one or more parameters of the incorrect URL request 305. The one or more parameters of the incorrect URL request 305 can include a portion of the URL in the URL request 305, such as a portion of a domain name, a subdomain, a path or a directory of the URL request. The echo server 350 can utilize text generator 365 to generate text comprising a number of words within a threshold of the client page 330 selected from the web server 340. The echo server 350 can generate the response page 370 based at least on a style of the client page 330 selected from the web server 350. The echo server 350 can cause the web server 340 to reply to the incorrect URL request 305 with a response comprising a success status with the response page 370.

As an example, the system 300 of the present solution can relate to a non-transitory computer readable medium storing program instructions for causing at least one processor of an echo server 350 to perform one or more tasks. For example, the instructions can cause the processor of an echo server 350 to receive, from a web server 340, an indication of an incorrect URL request 305 from a client device 102 being received by the web server 340. The instructions can cause the processor of an echo server 350 to establish a response page 370 based at least on a client page 330 selected from the web server 340. The instructions can cause the processor of an echo server 350 to provide content of the response page 370 based at least on one or more parameters of the uniform resource location (URL) of the incorrect URL request 305. The instructions can cause the processor of an echo server 350 to provide the response page 370 to the web server 340 to cause the web server 340 to provide the response page 370 in response to the incorrect URL request 305 to the client device 102 instead of an error code.

The instructions can cause the processor of an echo server 350 to receive the incorrect URL request 305 redirected to the echo server 350 by the web server 340, responsive to the web server 340 determining, by the incorrect request detector 310, that the URL of the incorrect URL request 305 identifies an unfound web page. The instructions can cause the processor of an echo server 350 to select the client page 330 of a plurality of client pages 330 of the web server 340 that was previously provided to the client device 102. The instructions can cause the processor of an echo server 350 to generate text for the content of the response page 370 based at least on one or more parameters of the incorrect URL request 305, wherein the text comprises a number of words within a threshold of the client page 330 selected from the web server 340. The instructions can cause the processor of an echo server 350 to generate the response page 370 based at least on a style of the client page 330 selected from the web server 340 or the echo server 350. The instructions can cause the processor of an echo server 350 to cause the web server 340 to reply to the incorrect URL request 305 with a response comprising a success status with the response page 370.

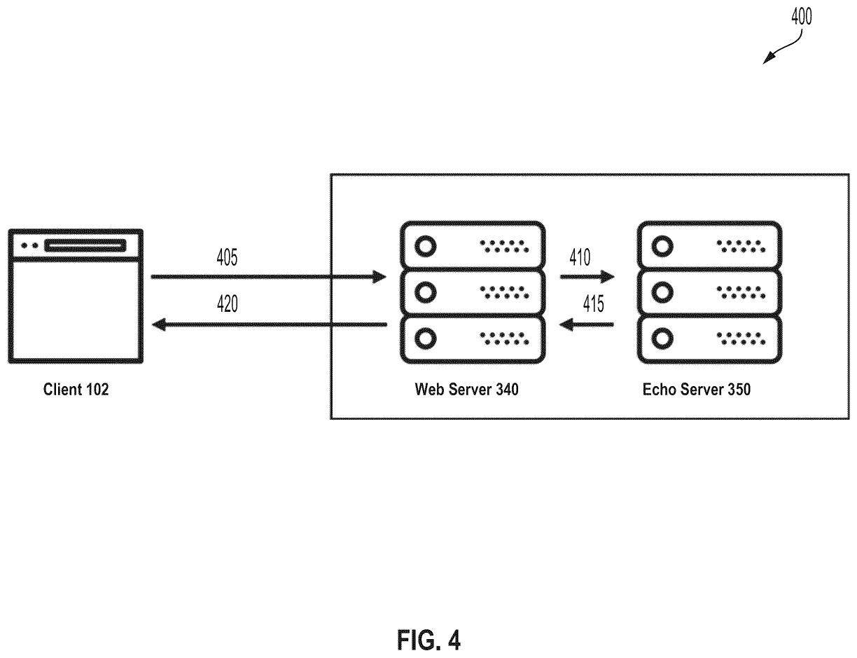

FIG. 4 illustrates an example of a communication process flow 400 between the components of a system 300 in accordance with an embodiment of the present solution. In the illustrated example, web server 340 and the echo server 350 can form a single entity, such as a single device, a single system or one or more devices on a single secured network, or a single cloud-based service or a platform. Web server 340 and the echo server 350 can also be separate entities on a network 104. The communication process flow 400 can include steps 405-420 completing the communication flow from the client 102, to the web server 350, to the echo server 355, back to the web server 350 and then finally back to the client 102. At a high level, a web server 340 can receive a URL request 305. When the requested page cannot be found, echo server 350 can randomly select a stored client page 330 that has been previously served or exposed to the client 102, such as for example a login page, and then dynamically generate a static web page (e.g., response page 370) with a similar style as the previously served client page 330. Also, based on the parameters of the URL from the URL request 305, the echo server 350 can generate a descriptive text of suitable length (e.g., length of text that is similar to that of the client page 330) and ensure that the generated web page with this text has a similar size to the client page. Then the echo server 350 can send the generated response page 370 to the web server 340, who will forward it to the client 102 with an http 200 status (e.g., success status).

At step 405 the client 102 can send a URL request 305 to the web server 340. The URL request 305 can include a URL having a portion (e.g., file path, directory or a fragment) that identifies a page that is not found on the web server 340. The web server 340 can then determine that the URL request 305 is an invalid or suspicious request and can forward it to the echo server 350 at step 410.

At step 410, web server 340 can also forward to the echo server 350 one or more client pages 330 that were stored in a database 320. Client pages 330 can be web pages that were previously served to the client 102. Echo server 350 can then utilize page generator 360 to generate a response page 370. Echo server 350 include in the content of the response page portions (e.g., parameters) from the URL request 305 as well as text, graphics, colors and any graphical arrangement from the one or more client pages 330 that were previously served to the client 102. Page generator 360 can organize and arrange the response page 370 to include the text generated based on the client pages 330 and the URL request 305 and make the length of the response page 370 to within a threshold amount of the length of the text in the one or more client pages 330.

At step 415 the echo server 370 can send to the web server 340 the response page 370. The response page 370 can include the content that matches that of the one or more client pages 330, in terms of the text size, color, graphics and arrangements. The response page 370 can include graphics, colors and arrangements same or similar as that found in the client page 330.

At step 420 the web server 340 can forward the response page 370 to the client 102 in response to the URL request 305. The web server 340 can send the response page 370 instead of the error code which the web server 340 would normally send for invalid or incorrect URL requests 305. Web server 340 can send to the client 102 a message indicating that the response was successfully completed (e.g., http 200 status) instead of an error code (e.g., error 401 or 404).

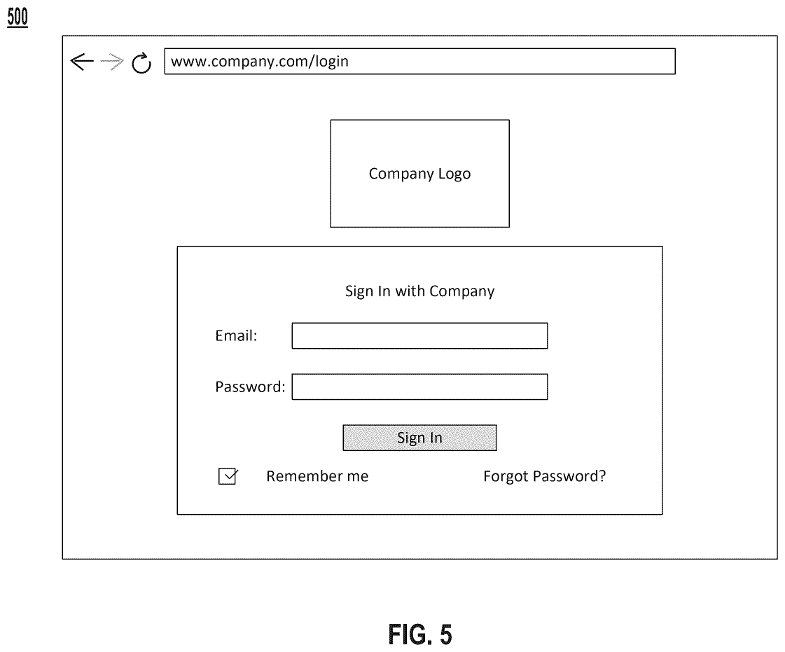

FIG. 5 refers to an example web page 500 that can be requested by client 102 and served to the client 102 in response to the request. The request can be a URL request 305. Web page 500 can include a login page for logging in to a company website. Web page 500 can include a company logo, one or more graphical features or colors which can be arranged in any arrangement. Web page 500 can include a prompt for signing in, including a prompt window for an email and a password. Web page 500 can include or correspond to a URL of “www.company.com/login.” Client 102 can request the web page 500 and upon serving the web page 500 to the client 102, web server 340 can store the web page 500 as a client page 330 in a database 320.

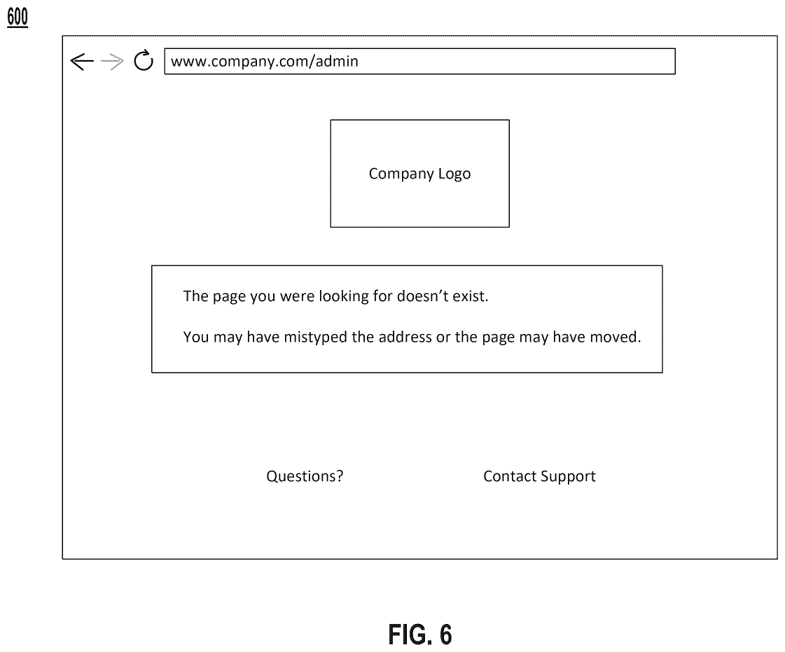

FIG. 6 refers to an example of a standard error web page 600 that can be provided to the client 102 in a system in which the present solution is not used. In the example illustrated in FIG. 6, the web page 600 can be provided to the client 102 in response to a determination by a web server 340 that the web page identified by the received URL request 305 cannot be found or cannot be provided. Web page 600 can be sent to the client 102 along with an error message and can indicate to the client 102 (e.g., user) that the page requested does not exist. The URL of the provided page can be or correspond to “www.company.com/admin” and may or may not request the URL included in the original URL request 305 for the page request.

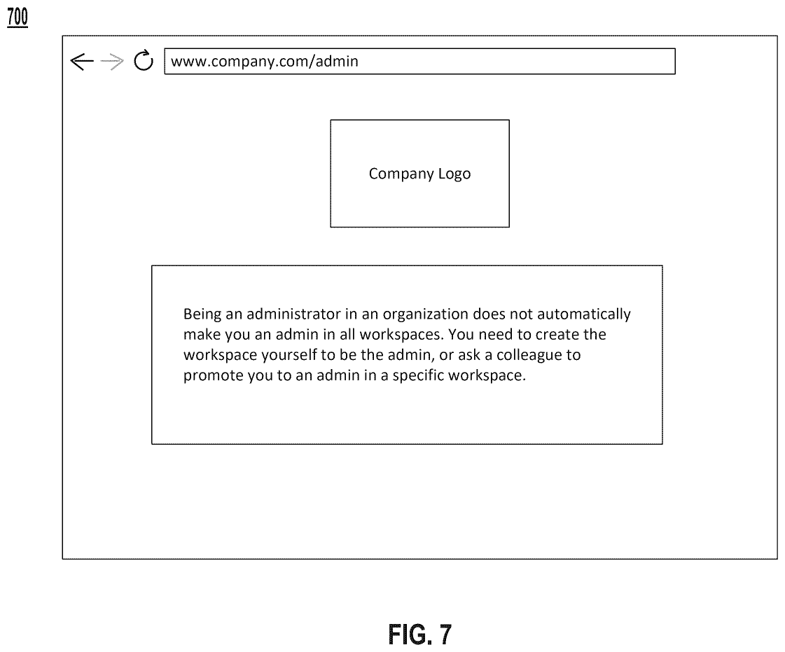

FIG. 7 refers to an example of a web page 700 that can be provided to the client 102 in accordance with present solution. In contrast to the example illustrated in FIG. 6 in which a standard error web page 600 can be provided in response to an incorrect URL request 305, in the example of FIG. 7 a web page 700 can correspond to dynamically generated static response web page 370. Web page 700 can be generated as a response page 370 by an echo server 350 in response to a URL request 305 being identified as an incorrect or invalid request. Web page 700 can be generated based on a prior provided client web page 330 that can be identified in the database 320 (e.g., such as a prior served login page in FIG. 5). Web page 700 can include the text that can be generated based on the text of the client pages 330 (e.g., a login page from page 5) or based on the parameters in the URL request (e.g., terms, such as “admin” in the URL of FIGS. 6 and 7). Using the parameters from the term and based on the text length from one or more client pages 330, response page 370 (e.g., web page 700) can include the text about the admin arranged in a format and style that mimics or conforms to a style and standard of a response previously provided to the client 102.

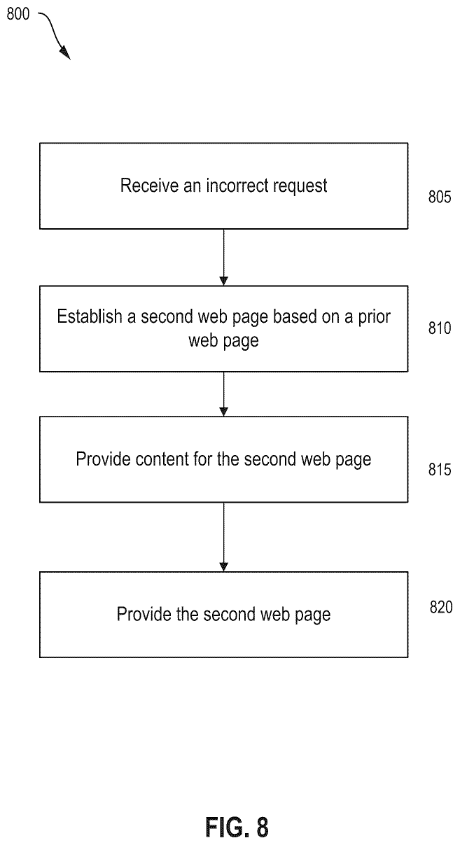

FIG. 8 illustrates a method 800 of automatically generating and serving web pages to a client in response to invalid URL requests. The method 800 can include acts 805-820. At act 805, the web server receives an incorrect request. At act 810, a second web page is established based on a prior web page. At act 815, content for the second web page is provided. At act 820, the second web page is provided.

At act 805, the echo server receives an incorrect request. An echo server can receive, from a web server, an indication of an incorrect request from a client device being received by web server. The echo server can receive the incorrect request redirected to the server by the web server. The web server can send the incorrect request to the echo server responsive to the web server determining the URL of the incorrect request identifies an unfound web page. The web server can identify that the received request identifies an unfound page in response to determining that a URL in the received requests includes a file path that does not correspond to a page that exist or a page that can be provided to the client.

At act 810, the echo server establishes a second web page based on a prior web page. The echo server can establish a second web page based at least on a web page selected from the web server. The web page selected from the web server can be a client page that was stored in a data base upon being served in response to a prior request by the client. The prior page can be a public web page that was previously requested by the same client that sent the incorrect request at step 805. The prior page can include a web page that includes content, text, graphics and arrangement of particular style, in accordance with the organization, company or enterprise that provides the web page. The echo server can select the prior stored web page of a plurality of prior stored web pages of the web server that were previously provided to the client device.

The second web page can be a response page that is generated based on the client page that was previously served to the same client. The second web page can be established or generated based on the content of the prior served client page. The second web page can be established or generated using the content, text, graphics and arrangement of the particular style of the prior served client page. For example, the second web page can include the same logo that was present in the prior served client page. The second web page can include the same color of the background that was present in the prior served client page. The second web page can include the same arrangement of graphics that were present in the prior served client page. The second web page can include the same length of text, within a threshold range, of the prior served client page.

At act 815, the echo server provides content for the second web page (e.g., response page 370). The echo server can provide content of the second web page based at least on one or more parameters of the uniform resource location (URL) of the incorrect request. The echo server can generate text for the content of the second page based at least on one or more parameters of the incorrect request. The echo server can generate text comprising a number of words within a threshold of the web page (e.g., prior served client page) selected from the web server. The echo server can generate the second web page based at least on a style of the web page (e.g., prior served client page) selected from the server.

At act 820, the echo server provides the second web page. The echo server can provide the second web page (e.g., response page) to the web server to cause the web server to provide the second web page in response to the incorrect request. The second web page (e.g., response page) can be provided to the client device instead of an error code. The echo server can cause the web server to reply to the incorrect request with a response comprising a success status with the second web page. For example, the echo server can send to the web server the second web page. The web server can forward the second web page to the requesting client along with a http 200 response indicating a successful response.

Various elements, which are described herein in the context of one or more embodiments, may be provided separately or in any suitable sub-combination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

We claim:

1. A method comprising:
receiving, by a server from a web server, an indication of an incorrect request from a client device being received by web server;
establishing, by the server, a second web page based at least on a web page selected from the web server;
providing, by the server, content of the second web page based at least on one or more parameters of the uniform resource location (URL) of the incorrect request; and
providing, by the server, the second web page to the web server to cause the web server to provide the second web page in response to the incorrect request to the client device instead of an error code.

2. The method of claim 1, further comprising receiving, by the server, the incorrect request redirected to the server by the web server, responsive to the web server determining the URL of the incorrect request identifies an unfound web page.

3. The method of claim 1, further comprising selecting, by the server, the web page of a plurality of web pages of the web server that was previously provided to the client device.

4. The method of claim 1, further comprising generating text for the content of the second page based at least on one or more parameters of the incorrect request.

5. The method of claim 4, further comprising generating text comprising a number of words within a threshold of the web page selected from the web server.

6. The method of claim 1, further comprising generating, by the server, the second web page based at least on a style of the web page selected from the server.

7. The method of claim 1, further comprising causing, by the server, the web server to reply to the incorrect request with a response comprising a success status with the second web page.

8. A system comprising:
one or more processors coupled to memory and configured to:
receive, from a web server, an indication of an incorrect request from a client device being received by web server;
establish a second web page based at least on a web page selected from the web server;
provide content of the second web page based at least on one or more parameters of the uniform resource location (URL) of the incorrect request; and
provide the second web page to the web server to cause the web server to provide the second web page in response to the incorrect request to the client device instead of an error code.

9. The system of claim 8, wherein the one or more processors receive the incorrect request redirected to the server by the web server, responsive to the web server determining the URL of the incorrect request identifies an unfound web page.

10. The system of claim 8, wherein the one or more processors select the web page of a plurality of web pages of the web server that was previously provided to the client device.

11. The system of claim 8, wherein the one or more processors generate text for the content of the second page based at least on one or more parameters of the incorrect request.

12. The system of claim 11, wherein the one or more processors generate text comprising a number of words within a threshold of the web page selected from the web server.

13. The system of claim 8, wherein the one or more processors generate the second web page based at least on a style of the web page selected from the server.

14. The system of claim 8, wherein the one or more processors cause the web server to reply to the incorrect request with a response comprising a success status with the second web page.

15. A non-transitory computer readable medium storing program instructions for causing at least one processor of a server to:
receive, from a web server, an indication of an incorrect request from a client device being received by web server;
establish a second web page based at least on a web page selected from the web server;
provide content of the second web page based at least on one or more parameters of the uniform resource location (URL) of the incorrect request; and
provide the second web page to the web server to cause the web server to provide the second web page in response to the incorrect request to the client device instead of an error code.

16. The non-transitory computer readable medium of claim 15, wherein the program instructions cause the at least one processor to receive the incorrect request redirected to the server by the web server, responsive to the web server determining the URL of the incorrect request identifies an unfound web page.

17. The non-transitory computer readable medium of claim 15, wherein the program instructions cause the at least one processor to select the web page of a plurality of web pages of the web server that was previously provided to the client device.

18. The non-transitory computer readable medium of claim 15, wherein the program instructions cause the at least one processor to generate text for the content of the second page based at least on one or more parameters of the incorrect request, wherein the text comprises a number of words within a threshold of the web page selected from the web server.

19. The non-transitory computer readable medium of claim 15, wherein the program instructions cause the at least one processor to generate the second web page based at least on a style of the web page selected from the server.

20. The non-transitory computer readable medium of claim 15, wherein the program instructions cause the at least one processor to cause the web server to reply to the incorrect request with a response comprising a success status with the second web page.
